(19) United States
(12) Patent Application Publication
(10) Pub. No.: US 2024/0146081 A1
(43) Pub. Date: May 2, 2024

(54) PORTABLE CHARGER

(71) Applicant: Shenzhen XinWeiDu Product Design Co., Ltd., Shenzhen (CN)

(72) Inventor: Fan ZHANG, Shenzhen (CN)

(73) Assignee: Shenzhen XinWeiDu Product Design Co., Ltd., Shenzhen (CN)

(21) Appl. No.: 18/151,462

(22) Filed: Jan. 8, 2023

(30) Foreign Application Priority Data
Oct. 31, 2022 (CN) 202222917171.3

(51) Int. Cl. H02J 7/00; H01R 13/639; H01R 24/60

(52) U.S. Cl. CPC H02J 7/0044; H01R 13/639; H01R 24/60; H02J 7/0045

(57) ABSTRACT

A portable charger includes a housing, a first plug-in assembly, and a charging assembly. The housing comprises an accommodating cavity and an avoidance recess formed in an outer surface. The first plug-in assembly includes a first plug rotatably connected to the housing and a locking element movably connected to the housing. The first plug is rotatable between a plug-in position where the first plug is protruding out of the outer surface of the housing and a storage position where the first plug is accommodated in the avoidance recess. The locking element is movable between a stop position limiting the rotation of the first plug at the storage position and an unlocking position avoiding from the first plug. The charging assembly includes a battery and a control board both arranged in the accommodating cavity. The control board is electrically connected to the first plug and the battery.

### CROSS-REFERENCE TO RELATED APPLICATIONS

This application claims priority to Chinese Patent Application No. 202222917171.3 with a filing date of Oct. 31, 2022. The content of the aforementioned application, including any intervening amendments thereto, is incorporated herein by reference.

### TECHNICAL FIELD

The present disclosure relates to the technical field of power banks, and in particular, to a portable charger.

### BACKGROUND

With continuous improvement of people's demand for the portability of power banks and other portable chargers, the portable chargers have become smaller and smaller, and mini pocket power banks appeared on the market. The portage charger includes a housing, a plug fixedly connected to the housing, a circuit board arranged in the housing, and a cylindrical battery arranged in the housing. The housing comprises an accommodating cavity, which is configured to mount the cylindrical battery formed by a plurality of stacked button cell batteries. The circuit board is electrically connected to the cylindrical battery and the plug. During use, the plug can be directly inserted into a mobile terminal such as a mobile phone, and the cylindrical battery can directly charge the mobile terminal. The volume of the power bank can be set to be slightly larger than that of the cylindrical battery. The power bank is very small and portable, and can be directly placed in a pocket or a satchel.

However, to facilitate docking with the mobile terminal, the plug of the portage charger needs to protrude out of the housing, and the portage charger forms a T-shaped structure. The plug takes up space, and is inconvenient to store. In addition, if the plug is placed in the pocket, it is easy to hurt the human body, causing discomfort; and if the plug is placed in the satchel, it is easy to touch other items in the satchel, causing potential safety hazards. Moreover, the plug protruding out of the housing is vulnerable to impact, resulting in poor contact between the plug and the circuit board, or even fracture and damage.

### SUMMARY

An objective of the present disclosure is to provide a portable charger, aiming to solve the technical problems that the existing portable charger is inconvenient to store, is easy to hurt the human body or cause potential safety hazards, and is easily damaged.

To achieve the above objective, the present disclosure adopts the following technical solutions:

Provided is a portable charger, including a housing, a first plug-in assembly, and a charging assembly.

The housing comprises an accommodating cavity and an avoidance recess formed in an outer surface.

The first plug-in assembly includes a first plug rotatably connected to the housing and a locking element movably connected to the housing. The first plug is rotatable between a plug-in position in which the first plug is protruded out of the outer surface of the housing and a storage position in which the first plug is accommodated in the avoidance recess. The locking element is movable between a stop position limiting the rotation of the first plug at the storage position and an unlocking position avoiding from the first plug.

The charging assembly includes a battery and a control board both arranged in the accommodating cavity. The control board is electrically connected to the first plug and the battery.

In one embodiment, the first plug is rotatably connected to a wall of the avoidance recess through a rotating shaft. The first plug-in assembly further includes a first elastic member connected to the housing. The first elastic member can provide an elastic force to the first plug for rotating towards the plug-in position when the first plug is located at the storage position.

In one embodiment, the first elastic member is connected to the rotating shaft. When the first plug is located at the storage position, the first elastic member generates an elastic force for driving the rotating shaft to rotate, such that the first plug rotates towards the plug-in position.

In one embodiment, the first elastic member is located on a movement trajectory of a tongue of the first plug. When the first plug is located at the storage position, the first elastic member elastically abuts against the tongue, and provides an elastic force to the tongue for moving towards the plug-in position.

In one embodiment, the first elastic member includes a tab rotatably connected to the housing and a torsion spring connected to the tab. An extension end of the torsion spring abuts against the housing. When the first plug is located at the storage position, the tongue abuts against the tab, and provides a pretightening force to the torsion spring.

In one embodiment, the housing comprises a first clamping structure. The rotating shaft comprises a second clamping structure. When the first plug is rotated to the plug-in position, the second clamping structure is clamped to the first clamping structure.

In one embodiment, the first clamping structure includes two limiting protrusions spaced from each other. A limiting gap is formed between the two limiting protrusions. The second clamping structure is a clamping member protruding from a peripheral wall of the rotating shaft. The clamping member is clamped to the limiting gap when the first plug is rotated to the plug-in position.

In one embodiment, the housing comprises a slideway. The locking element is slidably connected to the slideway. The locking element is slidable between the stop position and the unlocking position.

In one embodiment, the first plug-in assembly further includes a second elastic member connected to the locking element. The second elastic member can provide an elastic force to the locking element for moving towards the stop position.

In one embodiment, the portable charger further includes a second plug-in assembly. The second plug-in assembly includes a connecting wire and a second plug. Both ends of the connecting wire are electrically connected to the control board and the second plug, respectively. The housing comprises a first connecting hole communicated to the accommodating cavity, a limiting recess formed in the outer surface of the housing, and a second connecting hole for communicating an inner wall of the limiting recess and the outer surface of the housing. The connecting wire penetrates the first connecting hole and the second connecting hole. The second plug is accommodated in the limiting recess.

The present disclosure has the following technical effects with respect to the prior art: when the portable charger needs to be used, the locking element can be moved to the unlocking position, the first plug is then rotated to the plug-in position, and the tongue of the first plug protrudes out of the outer surface of the housing to be in plug-in fit with a socket of an external mobile terminal. In this way, the portable charger implements electric connection between the battery and the external mobile terminal through the first plug, and charges the external mobile terminal through the battery. When the charging is completed and the first plug is not used, the locking element can be first moved to the unlocking position, the first plug is then rotated to the storage position, the locking element is moved to the stop position, and the first plug is always stored in the avoidance recess under the limiting effect of the locking element, thereby preventing the first plug from being rotated out of the avoidance recess. In this way, the portable charger implements the storage of the first plug through the rotatable first plug, the avoidance recess formed in the outer surface of the housing, and the locking element for locking the first plug; and the portable charger is changed from a T-shaped structure to a strip-shaped structure, thereby saving the space, and facilitating the storage. Since the first plug is stored in the avoidance recess, when the portable charger is placed in a pocket, it does not cause discomfort to a human body; when the portable charger is placed in a satchel, it does not cause potential safety hazards; and the damage of the first plug due to external bumps or impacts can be avoided, thereby prolonging the service life of the mobile terminal.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a three-dimensional structural diagram of a portable charger according to embodiments of the present disclosure, where the first plug is located at the plug-in position;

FIG. 2 is a sectional view of a portable charger according to FIG. 1;

FIG. 3 is a three-dimensional structural diagram of a portable charger according to embodiments of the present disclosure, where the first plug is located at the storage position;

FIG. 4 is a sectional view of a portable charger according to FIG. 3;

FIG. 5 is an exploded view of a portable charger according to one embodiment of the present disclosure; and

FIG. 6 is an exploded view of a portable charger according to another embodiment of the present disclosure.

### REFERENCE NUMERALS

10. Housing; 11. Body part; 12. Operation part; 121. Operation surface; 13. Upper housing; 14. Lower housing; 101. Accommodating cavity; 1011. Power source cavity portion; 1012. Mounting cavity portion; 102. Avoidance recess; 103. Slideway; 104. Limiting recess; 105. First connecting hole; 106. Second connecting hole; 107. Jack; 20. First plug-in assembly; 21. First plug; 211. Tongue; 212. Rotating shaft; 22. Locking element; 231. First elastic member; 2311. Torsion spring; 2312. Tab; 24. Second elastic member; 25. Clamping member; 26. Limiting protrusion; 27. Mounting member; 30. Charging assembly; 31. Battery; 32. Control board; 33. Bayonet socket; 40. Second plug-in assembly; 41. Second plug; 42. Connecting wire.

### DETAILED DESCRIPTION OF THE EMBODIMENTS

The embodiments of the present disclosure are described below in detail. Examples of the embodiments are shown in the accompanying drawings. The same or similar numerals represent the same or similar elements or elements having the same or similar functions throughout the specification. The embodiments described below with reference to the accompanying drawings are exemplary, are used only for explaining the present disclosure, and should not be construed as a limitation to the present disclosure.

In the description of the present disclosure, it should be understood that orientations or position relationships indicated by terms “length”, “width”, “upper”, “lower”, “front”, “rear”, “left”, “right”, “vertical”, “horizontal”, “top”, “bottom”, “inside”, “outside”, and the like are orientations or position relationships as shown in the drawings, for ease of describing the present disclosure and simplifying the description, rather than indicating or implying that the mentioned devices or elements must have a specific orientation and must be established and operated in a specific orientation, and thus, these terms cannot be understood as a limitation to the present disclosure.

Moreover, the terms such as “first” and “second” are used only for the purpose of description and should not be construed as indicating or implying a relative importance, or implicitly indicating a quantity of indicated technical features. Thus, features defined with “first” and “second” may explicitly or implicitly include one or more of the features. In the description of the present disclosure, the term “a plurality of” means two or more, unless otherwise specifically defined.

In the present disclosure, unless otherwise clearly specified, the terms “installation”, “interconnection”, “connection” and “fixation” are intended to be understood in a broad sense. For example, the connection may be a fixed connection, removable connection or integral connection; may be a mechanical connection or electrical connection; may be a direct connection or indirect connection using a medium; and may be a communication or interaction between two elements. Those of ordinary skill in the art may understand the specific meanings of the above terms in the present disclosure based on specific situations.

To make the objectives, technical solutions and the advantages of the present disclosure clearer, the present disclosure is described in further detail below with reference to the drawings and embodiments.

The present disclosure provides a portable charger, configured to charge an external mobile terminal. The mobile terminal includes, but is not limited to, a mobile phone, a tablet personal computer, an e-book reader, a smart wearable device, etc.

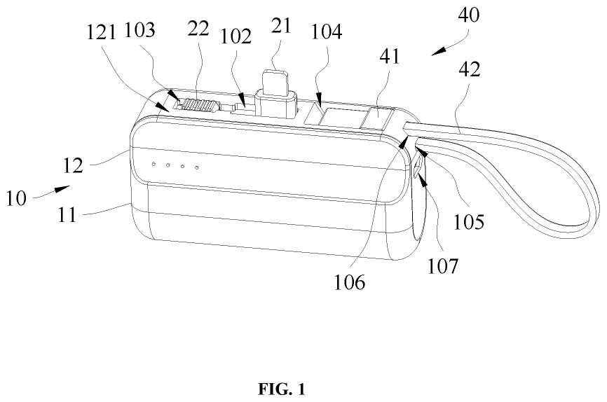

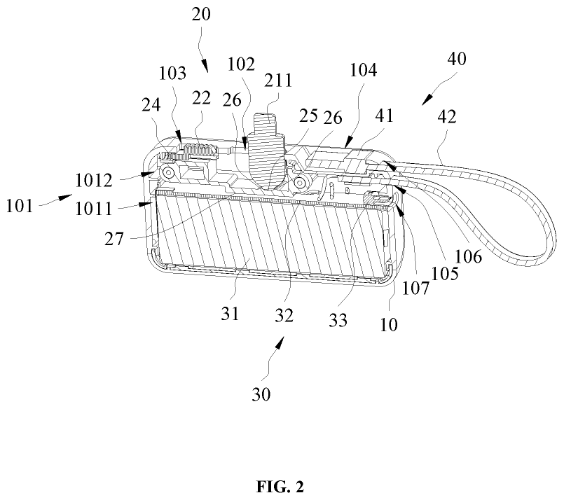

Referring to FIG. 1 and FIG. 2, the portable charger includes a housing 10, a first plug-in assembly 20, and a charging assembly 30.

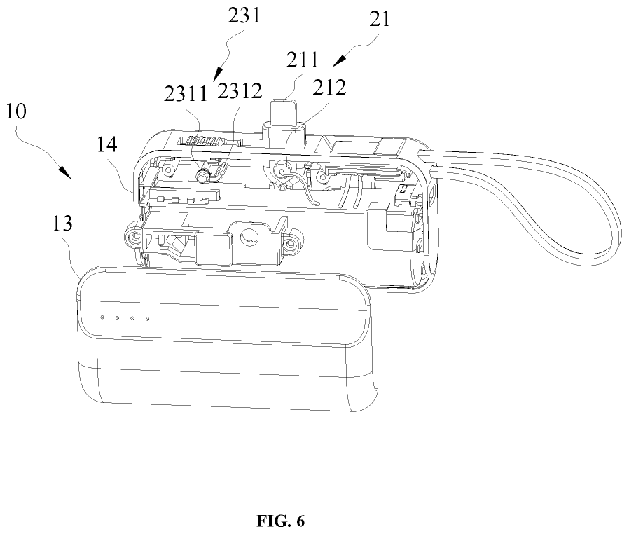

The housing 10 comprises an accommodating cavity 101 and an avoidance recess 102 formed in an outer surface. The avoidance recess 102 can be spaced from or communicated with the accommodating cavity 101. Referring to FIG. 6, the housing 10 includes an upper housing 13 and a lower housing 14. The upper housing 13 and the lower housing 14 abut against each other to form the accommodating cavity 101.

The first plug-in assembly 20 includes a first plug 21 and a locking element 22. The first plug 21 is rotatably connected to the housing 10, and the locking element 22 is movably connected to the housing 10. The first plug 21 includes, but is not limited to, a Lighting plug, a Type-B plug, a Type-C plug, etc., as long as it can be electrically plugged with a plug of an external mobile terminal, and there is no limitation herein.

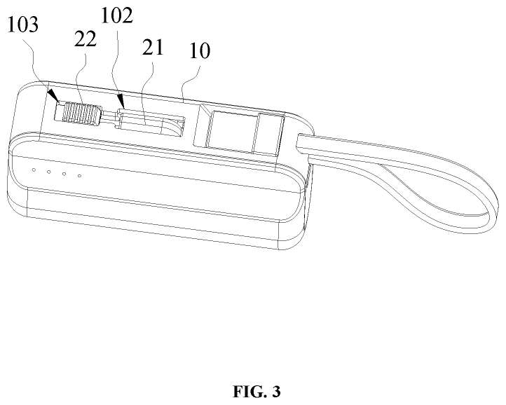

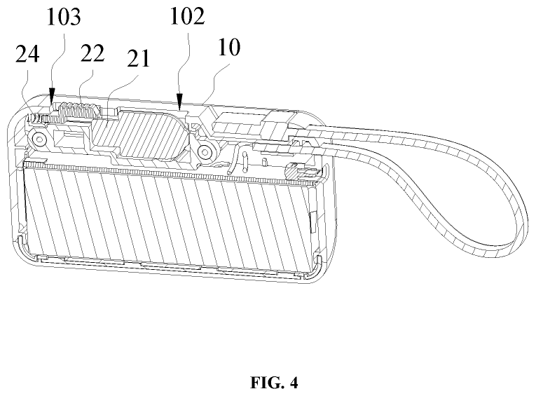

Referring to FIG. 3 and FIG. 4, the first plug 21 is rotatable between a plug-in position and a storage position. When the first plug 21 is located at the plug-in position, it protrudes out of the outer surface of the housing 10. Specifically, the first plug 21 includes a rotating shaft 212 and a tongue 211 connected to the rotating shaft 212. The rotating shaft 212 is rotatably connected to the housing 10, and the tongue 211 can be in plug-in fit with a socket of the external mobile terminal. When the first plug 21 is located at the storage position, it is accommodated in the avoidance recess 102. That is, the rotating shaft 212 and the tongue 211 are both located in the avoidance recess 102. The first plug 21 can be rotatably connected to a wall of the avoidance recess 102 through the rotating shaft 212. In other embodiments, the first plug 21 can also be connected to the outside of the avoidance recess 102, for example, rotatably connected to the housing 10 through other structural members. As long as the first plug 21 is in a storage state, it is located in the avoidance recess 102. The plug-in position may be any position where the first plug is protruded out of the outer surface of the housing 10. To facilitate the plug-in between the first plug 21 and the socket of the external mobile terminal, when the first plug 21 is located at the plug-in position, it is perpendicular to the outer surface of the housing 10. It should be noted that the rotation of the first plug 21 between the plug-in position and the storage position can be completed manually, or can be assisted through an electric structure or other mechanical structures, and can also be completed by combining at least two of the above several modes, and there is no limitation herein. The rotatable connection between the rotating shaft 212 and the housing 10 may be damping connection, such that the first plug 21 can be kept at the current angle without external force.

Referring to FIG. 2 and FIG. 4, the locking element 22 is movable between a stop position and an unlocking position. When the locking element 22 is located at the stop position, it can limit the rotation of the first plug 21 at the storage position, such that the first plug 21 is kept at the storage position. When the locking element 22 is located at the unlocking position, it avoids from the first plug 21, such that the plug is rotatable from the storage position to the plug-in position. It should be noted that the movement of the locking element 22 between the stop position and the unlocking position can be completed manually, or can be assisted through an electric structure or other mechanical structures, and can also be completed by combining at least two of the above several modes, and there is no limitation herein.

Referring to FIG. 2, the charging assembly 30 includes a battery 31 and a control board 32 both arranged in the accommodating cavity 101. The housing 10 protects the battery 31 and the control board 32. The control board 32 is electrically connected to the first plug 21 and the battery 31, such that the battery 31 charges the first plug 21. The battery 31 may be cylindrical, thereby reducing the overall volume of the portable charger. Specifically, the battery 31 may include a plurality of button cell batteries 31 stacked to form a cylindrical battery 31 module. In other embodiments, the battery 31 may also be prism-shaped or plate-shaped, and there is no limitation herein.

Referring to FIG. 1 and FIG. 2, the housing 10 includes a body part 11 and an operation part 12. In graphic embodiments, the body part 11 is substantially cylindrical; and the operation part 12 is substantially quadrangular, and comprises an operation surface 121 facing away from the body part 11. The first plug-in assembly 20 is disposed on the operation part 12, and the avoidance recess 102 is formed in the operation surface 121. The accommodating cavity 101 may include a power supply cavity portion 1011 arranged in the body part 11 and a mounting cavity portion 1012 arranged in the operation part 12. The power supply cavity portion 1011 is a substantially cylindrical cavity matched with the battery 31. The battery 31 can be mounted in the power supply cavity portion 1011, and the circuit board is mounted in the mounting cavity portion 1012.

When the portable charger needs to be used, the locking element 22 can be moved to the unlocking position, the first plug 21 is then rotated to the plug-in position, and the tongue 211 of the first plug 21 protrudes out of the outer surface of the housing 10 to be in plug-in fit with the socket of the external mobile terminal. In this way, the portable charger implements electric connection between the battery 31 and the external mobile terminal through the first plug 21, and charges the external mobile terminal through the battery 31. When the charging is completed and the first plug 21 is not used, the locking element 22 can be first moved to the unlocking position, the first plug 21 is then rotated to the storage position, the locking element 22 is moved to the stop position, and the first plug 21 is always stored in the avoidance recess 102 under the limiting effect of the locking element 22, thereby preventing the first plug 21 from being rotated out of the avoidance recess 102. In this way, the portable charger implements the storage of the first plug 21 through the rotatable first plug 21, the avoidance recess 102 formed in the outer surface of the housing 10, and the locking element 22 for locking the first plug 21; and the portable charger is changed from the T-shaped structure to the strip-shaped structure, thereby saving the space, and facilitating the storage. Since the first plug 21 is stored in the avoidance recess 102, when the portable charger is placed in the pocket, it does not cause discomfort to a human body; when the portable charger is placed in the satchel, it does not cause potential safety hazards; and the damage of the first plug 21 due to external bumps or impacts can be avoided, thereby prolonging the service life of the mobile terminal.

There may be one or more first plug-in assemblies 20, and there is no limitation herein. In this embodiment, there is one first plug-in assembly 20, and the first plug 21 is disposed in the middle of the operation part 12.

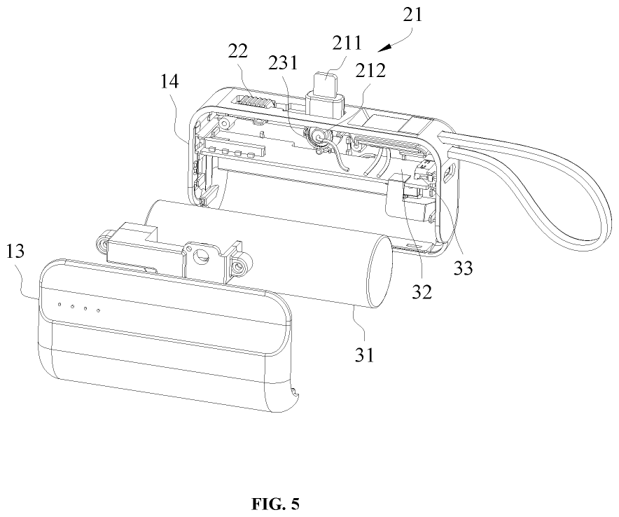

As one embodiment, referring to FIG. 5 and FIG. 6, the first plug-in assembly 20 further includes a first elastic member 231 connected to the housing 10. When the first plug 21 is located at the storage position, the first elastic member 231 can provide an elastic force to the first plug 21 for rotating towards the plug-in position, to assist the rotation of the first plug 21 from the storage position to the plug-in position. That is to say, when the first plug 21 is located at the storage position and the locking element 22 is located at the stop position, the first plug 21 is acted on the first elastic member 231, and the first elastic member 231 generates an elastic pretightening force to the first plug 21; and after the locking element 22 moves to the unlocking position, the first elastic member 231 releases the pretightened elastic force, and the first plug 21 is rotated out of the avoidance recess 102 under the action of the elastic force. The portable charger implements automatic ejection of the first plug 21 from the avoidance recess 102 by providing the first elastic member 231, such that the rotating-out process of the first plug 21 is more labor-saving. It should be noted that the first plug 21 can be automatically rotated to the plug-in position under the action of the elastic force, can also be rotated between the storage position and the plug-in position, and is then rotated to the plug-in position through a manual structural member or other structural members. When the first plug 21 is rotated to the plug-in position, it can abut against the wall of the avoidance recess 102, such that continuous rotation of the first plug 21 is limited through the wall.

Optionally, as shown in FIG. 5, the first elastic member 231 is connected to the rotating shaft 212. When the first plug 21 is located at the storage position, the first elastic member 231 generates an elastic force for driving the rotating shaft 212 to rotate, such that the first plug 21 rotates towards the plug-in position. In this way, the first elastic member 231 can rotate the first plug 21 by driving the rotating shaft 212. For example, the first elastic member 231 may be a torsion spring (not marked in the figure), the torsion spring is sleeved on the rotating shaft 212, and an extension end of the torsion spring abuts against the housing 10. When the first plug 21 is located at the storage position, the rotating shaft 212 twists the torsion spring, such that the torsion spring accumulates force. When the locking element 22 is located at the unlocking position, the torsion spring releases the elastic force and drives the rotating shaft 212 to twist, such that the first plug 21 rotates towards the plug-in position.

Optionally, as shown in FIG. 6, the first elastic member 231 is located on a movement trajectory of a tongue 211 of the first plug 21. When the first plug 21 is located at the storage position, the first elastic member 231 elastically abuts against the tongue 211, and provides an elastic force to the tongue 211 for moving towards the plug-in position. In this way, the first elastic member 231 can rotate the first plug 21 by shifting the tongue 211. The tongue 211 moves in a circle around the rotating shaft 212, and at least part of the first elastic member 231 is located on the movement trajectory of the side of the tongue 211 facing away from the plug-in position. When the first plug 21 is located at the storage position, it abuts against the first elastic member 231 to elastically deform, such that the first elastic member 231 accumulates force.

For example, the first elastic member 231 includes a tab 2312 rotatably connected to the housing 10 and a torsion spring 2311 connected to the tab 2312. An end of the tab 2312 is located on the movement trajectory of the tongue 211 facing away from the plug-in position, the torsion spring 2311 can be sleeved on the rotating shaft of the tab 2312, and an extension end of the torsion spring 2311 abuts against the housing 10. When the first plug 21 is located at the storage position, the tongue 211 abuts against the tab 2312, and the tab 2312 drives the torsion spring 2311 to twist to provide a pretightening force to the torsion spring 2311. When the locking element 22 is located at the unlocking position, the torsion spring 2311 releases the elastic force and drives the tab 2312 to rotate, and the tab 2312 shifts the tongue 211 to move in a circle, such that the first plug 21 rotates towards the plug-in position.

To ensure stable plug-in between the first plug 21 and the socket of the external mobile terminal, the housing 10 comprises a first clamping structure, the rotating shaft 212 comprises a second clamping structure, and when the first plug 21 is rotated to the plug-in position, the second clamping structure is clamped to the first clamping structure. In this way, random rotation of the first plug 21 is avoided, and the stability of the first plug 21 at the plug-in position is improved. It should be noted that after the locking element 22 moves to the unlocking position, the first plug 21 is rotatable between the storage position and the plug-in position under the elastic force of the first elastic member 231, and then rotated to the plug-in position under the external force, such that automatic clamping between the first clamping structure and the second clamping structure can be implemented. When the first plug 21 needs to be stored, the clamping between the first clamping structure and the second clamping structure can release the shifting of the first plug 21 through the external force, such that the first plug 21 is rotated towards the storage position.

Optionally, referring to FIG. 2, the first clamping structure includes two limiting protrusions 26 spaced from each other. A limiting gap is formed between the two limiting protrusions 26. The second clamping structure is a clamping member 25 protruding from a peripheral wall of the rotating shaft 212. When the rotating shaft 212 rotates, the clamping member 25 is movable in a circle around the rotating shaft 212, and the two limiting protrusions 26 are located on the movement trajectory of the clamping member 25. When the first plug 21 is rotated towards the plug-in position, the clamping member 25 moves towards the limiting gap. When the clamping member 25 abuts against the limiting protrusion 26 close to the clamping member 25, it abuts against the limiting protrusion 26 under the external force to generate slight elastic deformation, to cross over the limiting protrusion 26 to enter the limiting gap. The limiting protrusion 26 subjected to the elastic deformation is reset, and the two limiting protrusions 26 limit the clamping member 25 in the limiting gap together, thereby limiting the rotation of the first plug 21. Specifically, a mounting member 27 can be arranged in the housing 10. The mounting member 27 can be rotatably connected to the rotating shaft 212, and comprises the limiting protrusions 26.

There are many ways to movably connect the locking element 22 and the housing 10, such as slidable connection, rotatable connection, and plug-in connection. In this embodiment, the locking element 22 is slidably connected to the housing 10.

Specifically, referring to FIG. 1 and FIG. 2, the housing 10 comprises a slideway 103, and the slideway 103 can be disposed on the operation surface 121 of the housing 10. The slideway 103 extends toward the avoidance recess 102, and is communicated with the avoidance recess 102. The locking element 22 is slidably connected to the slideway 103. The locking element 22 is slidable between the stop position and the unlocking position. When the locking element 22 is located at the stop position, it is inserted into the avoidance recess 102 and located on the movement trajectory of the side of the tongue 211 towards the plug-in position, the tongue 211 of the first plug 21 located at the storage position abuts against the inner side of the locking element 22, and the locking element 22 limits the rotation of the first plug 21 towards the plug-in position. When the locking element 22 is located at the unlocking position, it is distant from the avoidance recess 102 to avoid from the movement trajectory of the tongue 211, and the first plug 21 is rotated out of the avoidance recess 102. It should be noted that the sliding of the locking element 22 can be completed manually, or can be assisted through an electric structure or other mechanical structures, and can also be completed by combining at least two of the above several modes, and there is no limitation herein.

As one embodiment, the locking element 22 automatically slides towards the stop position under the elastic force of the second elastic member 24.

Specifically, referring to FIG. 2, the first plug-in assembly 20 further includes a second elastic member 24 connected to the locking element 22. The second elastic member 24 can provide an elastic force to the locking element 22 for moving towards the stop position. The second elastic member 24 is located in the slideway 103 and located on the side of the locking element 22 facing away from the avoidance recess 102. The second elastic member 24 may be a spring, and a deformation direction of the spring is the same as an extension direction of the slideway 103. When the locking element 22 slides towards the unlocking position under the external force, the spring is compressed, and generates an elastic force to the locking element 22 towards the avoidance recess 102. When the external force is removed, the spring releases the elastic force, and the locking element 22 slides towards the stop position under the elastic force. When the locking element 22 is located at the stop position, the spring can still be in a compressed state, such that the locking element 22 is stably stopped at the stop position. In this way, a user only needs to shift the locking element 22 to slide towards the unlocking position, and the stop process of the locking element 22 can be automatically completed through the second elastic member 24, such that the operation process is more labor-saving.

Optionally, a guide surface is provided on the side of the locking element 22 towards the avoidance recess 102. When the locking element 22 is located at the stop position, and the first plug 21 is rotated towards the storage position under the external force, the tongue 211 can abut against the guide surface, and push the guide surface during rotation to enable the locking element 22 to slide towards an avoidance position until the tongue 211 bypasses the locking element 22 to reach the storage position. The locking element 22 can automatically reset to the stop position under the elastic force of the second elastic member 24, thereby saving the step of shifting the locking element 22 when the first plug 21 is stored, such that the operation process is more convenient and labor-saving.

As one embodiment, referring to FIG. 1 and FIG. 2, the portable charger further includes a second plug-in assembly 40. The second plug-in assembly 40 includes a connecting wire 42 and a second plug 41. Both ends of the connecting wire 42 are connected to the control board 32 and the second plug 41, respectively. The housing 10 is further having a first connecting hole 105, a second connecting hole 106, and a limiting recess 104. The limiting recess 104 is formed in the outer surface of the housing 10, specifically formed in the operation surface 121 of the operation part 12. The first connecting hole 105 communicates the outer surface of the housing 10 and a cavity wall of the accommodating cavity 101, specifically communicates a cavity wall of the mounting cavity portion 1012. The second connecting hole 106 communicates an inner wall of the limiting recess 104 and the outer surface of the housing 10, specifically communicates a recess side wall of the limiting recess 104 and the outer surface of the housing 10. The connecting wire 42 penetrates the first connecting hole 105 and the second connecting hole 106. The second plug 41 is accommodated in the limiting recess 104. The length of the connecting wire 42 is greater than a distance between the first connecting hole 105 and the second connecting hole 106. One end of the connecting wire 42 is inserted from the outside into the second connecting hole 106 and electrically connected to the control board 32, and the other end of the connecting wire 42 is inserted into the limiting recess 104 through the first connecting hole 105 and connected to the second plug 41. During use, the second plug 41 can be taken out from the limiting recess 104, and the connecting wire 42 is pulled, such that the connecting wire 42 penetrates the inner wall of the limiting recess 104. In this way, the portable charger can be plugged into a socket of an external device through the second plug to charge the external device, and can also be electrically plugged into an external power supply through the second plug 41, such that the external power supply can charge the battery through the connecting wire 42. The connecting wire 42 extends the distance between the second plug 41 and the housing 10, which can improve the flexibility of electric connection between the portable charger and the external device or the external power supply. When the second plug 41 is located in the limiting recess 104, the part of the connecting wire 42 located between the first connecting hole 105 and the second connecting hole 106 is located outside the housing 10 to form a hoop-shaped structure, which is convenient to connect or hang the portable charger on other structural members. When the hoop-shaped structure is not needed, a redundant part outside the connecting wire 42 is plugged into the mounting cavity portion 1012 through the first connecting hole 105 to save the space.

Optionally, the second plug 41 can be clamped into the limiting recess 104 to avoid falling from the limiting recess 104 when being not used. The clamping of the second plug 41 in the limiting recess 104 can be implemented through a clamping structure, and can also be implemented through a frictional force between the second plug 41 and the recess side wall of the limiting recess 104.

The second plug 41 includes, but is not limited to, a Lighting plug, a Type-B plug, a Type-C plug, a USB plug, etc., as long as it can be electrically plugged with the plug of the external mobile terminal. The type of the second plug 41 and the type of the first plug 21 may be the same or different, and there is no limitation herein.

There may be one or more second plug-in assemblies 40, and there is no limitation herein. In this embodiment, there is one second plug-in assembly 40, and the limiting recess 104 is disposed on an edge of the operation part 12.

In other embodiments, the first connecting hole 105 and the second connecting hole 106 may not be provided, only a third connecting hole connecting the cavity wall of the accommodating cavity 101 and the inner wall of the limiting recess 104 is provided, and the connecting wire 42 penetrates the third connecting hole. When the second plug 41 is located in the limiting recess 104, most of the connecting wire 42 is located in the accommodating cavity 101 to save the space. When the second plug 41 is taken out from the limiting recess 104, the connecting wire 42 can be pulled out from the accommodating cavity.

To charge the battery 31, referring to FIG. 2, the portable charger further includes a bayonet socket 33 electrically plugged with the external power supply. The bayonet socket 33 is electrically connected to the control board 32 and exposed to the housing 10. When an electric quantity of the battery 31 is used up, the external power supply can be plugged into the bayonet socket 33, such that the external power supply charges the battery 31. Specifically, jacks 107 communicated to the accommodating cavity 101 can be formed in the body part 11 of the housing 10, and the bayonet socket 33 is arranged corresponding to the jacks 107, such that the plug of the external power supply is electrically connected to the bayonet socket 33 through the jacks 107. It should be noted that there may be one or more bayonet sockets 33. The bayonet socket 33 includes, but is not limited to, a Lighting bayonet socket 33, a Type-B bayonet socket 33, a Type-C bayonet socket 33, a USB bayonet socket 33, etc., as long as it can be electrically plugged with the plug of the external mobile terminal, and there is no limitation herein.

The above descriptions are only preferred embodiments of the present disclosure, which only specifically describe the technical principle of the present disclosure. These descriptions are merely intended to explain the principles of the present disclosure, and may not be construed as limiting the protection scope of the present disclosure in any way. Based on the explanations herein, any modifications, equivalent replacements and improvements made within the spirit and principles of the present disclosure should be included within the protection scope of the present disclosure, and those skilled in the art can think of other specific implementations of the present disclosure without creative work.

What is claimed is:

1. A portable charger, comprising:
a housing having an accommodating cavity and an avoidance recess formed in an outer surface;
a first plug-in assembly comprising a first plug rotatably connected to the housing and a locking element movably connected to the housing, wherein the first plug is rotatable between a plug-in position in which the first plug is protruded out of the outer surface of the housing and a storage position in which the first plug is accommodated in the avoidance recess, and the locking element is movable between a stop position for limiting the rotation of the first plug at the storage position and an unlocking position for avoiding from the first plug; and
a charging assembly comprising a battery and a control board both arranged in the accommodating cavity, wherein the control board is electrically connected to the first plug and the battery.

2. The portable charger according to claim 1, wherein the first plug is rotatably connected to a wall of the avoidance recess through a rotating shaft; the first plug-in assembly further comprises a first elastic member connected to the housing; and the first elastic member provides an elastic force to the first plug for rotating towards the plug-in position when the first plug is located at the storage position.

3. The portable charger according to claim 2, wherein the first elastic member is connected to the rotating shaft; and when the first plug is located at the storage position, the first elastic member generates an elastic force for driving the rotating shaft to rotate, such that the first plug rotates towards the plug-in position.

4. The portable charger according to claim 2, wherein the first elastic member is located on a movement trajectory of a tongue of the first plug; and when the first plug is located at the storage position, the first elastic member elastically abuts against the tongue, and provides an elastic force to the tongue for moving towards the plug-in position.

5. The portable charger according to claim 4, wherein the first elastic member comprises a tab rotatably connected to the housing and a torsion spring connected to the tab; an extension end of the torsion spring abuts against the housing; and when the first plug is located at the storage position, the tongue abuts against the tab, and provides a pretightening force to the torsion spring.

6. The portable charger according to claim 2, wherein the housing comprises a first clamping structure; the rotating shaft comprises a second clamping structure; and when the first plug is rotated to the plug-in position, the second clamping structure is clamped to the first clamping structure.

7. The portable charger according to claim 6, wherein the first clamping structure comprises two limiting protrusions spaced from each other; a limiting gap is formed between the two limiting protrusions; the second clamping structure is a clamping member protruding from a peripheral wall of the rotating shaft; and the clamping member is clamped to the limiting gap when the first plug is rotated to the plug-in position.

8. The portable charger according to claim 1, wherein the housing comprises a slideway; the locking element is slidably connected to the slideway; and the locking element is slidable between the stop position and the unlocking position.

9. The portable charger according to claim 1, wherein the first plug-in assembly further comprises a second elastic member connected to the locking element; and the second elastic member provides an elastic force to the locking element for moving towards the stop position.

10. The portable charger according to claim 1, further comprising a second plug-in assembly, wherein the second plug-in assembly comprises a connecting wire and a second plug; two ends of the connecting wire are electrically connected to the control board and the second plug, respectively; the housing comprises a first connecting hole communicated to the accommodating cavity, a limiting recess formed in the outer surface of the housing, and a second connecting hole for communicating an inner wall of the limiting recess and the outer surface of the housing; the connecting wire penetrates the first connecting hole and the second connecting hole; and the second plug is accommodated in the limiting recess.
